(19) United States
(12) Patent Application Publication
(10) Pub. No.: US 2006/0140741 A1
(43) Pub. Date: Jun. 29, 2006

(54) Screw

(76) Inventor: Teng-Hung Lin, Kaohsiung Hsien (TW)

Correspondence Address: TENG-HUNG LIN, 235 Chung-Ho, Box 8-24, Taipei, TW

(21) Appl. No.: 11/022,409

(22) Filed: Dec. 27, 2004

(51) Int. Cl. F16B 35/04

(52) U.S. Cl. 411/411

(57) ABSTRACT

A screw with better anti-pull quality. The screw has a rod body and at least one thread formed on the rod body. The inclination of the lower face of the thread is larger than zero degree, while smaller than the inclination of the upper faces of the thread, whereby the thread of the screw is downward inclined to achieve a better anti-pull effect.

### BACKGROUND OF THE INVENTION

The present invention is related to an improved screw. The screw has a rod body and at least one thread formed on the rod body. The inclination of the lower face of the thread is larger than zero degree, while smaller than the inclination of the upper faces of the thread, whereby the thread of the screw is downward inclined to achieve better anti-pull effect.

Different types of screws have different structures according to the qualities of the work pieces in which the screws are screwed. However, with respect to all types of screws, it is required that the screws can be quickly firmly screwed into the work pieces and have good anti-pull effect. Therefore, the conventional screws are designed with drilling structure and chip-exhausting structure. The thread of the conventional screw has an upward inclined structure for enhancing the anti-pull quality after the screw is screwed into the work piece. According to such structure, the inclination of the lower face of the thread of the screw is larger than the inclination of the upper face of the thread of the screw so that the thread is upward inclined. Generally, it is deemed that the upward inclined thread has larger abutting face and thus can achieve better anti-pull effect.

It is proved through tests that the screw with upward inclined thread has better anti-pull quality than the screw in which the inclination of upper face of the thread is equal to the inclination of lower face of the thread. However, the screw with upward inclined thread still can hardly achieve excellent anti-pull effect.

### SUMMARY OF THE INVENTION

It is therefore a primary object of the present invention to provide an improved screw with better anti-pull quality. The screw has a rod body and at least one thread formed on the rod body. The inclination of the lower face of the thread is larger than zero degree, while smaller than the inclination of the upper faces of the thread, whereby the thread of the screw is downward inclined to achieve a better anti-pull effect.

The present invention can be best understood through the following description and accompanying drawings wherein:

### BRIEF DESCRIPTION OF THE DRAWINGS

FIG. 1 is a perspective view of a first embodiment of the present invention;

FIG. 2 is an enlarged view of the thread of the first embodiment according to FIG. 1;

FIG. 3 is a sectional view of the first embodiment of the present invention according to FIG. 1;

FIG. 4 is a perspective view of a second embodiment of the present invention;

FIG. 5 is an enlarged view of the thread of the second embodiment according to FIG. 4;

FIG. 6 is an enlarged view of the thread of another aspect of the second embodiment;

FIG. 7 is a perspective view of a third embodiment of the present invention;

FIG. 8 is an enlarged view of the thread of the third embodiment according to FIG. 7; and

FIG. 9 is an enlarged view of the thread of another aspect of the third embodiment.

### DETAILED DESCRIPTION OF THE PREFERRED EMBODIMENTS

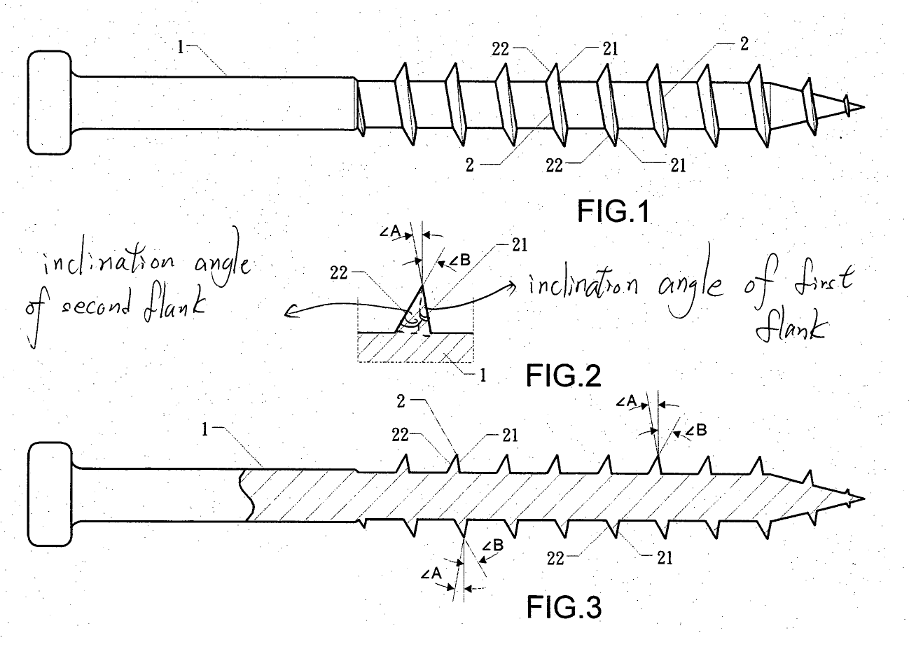

Please refer to FIGS. 1 to 3. According to a first embodiment, the screw 1 of the present invention has a rod body and a thread 2 formed on the rod body. The inclination A of the lower face 21 of the thread 2 is larger than zero degree, while smaller than the inclination B of the upper face 22 of the thread 2. That is, the inclination B of the upper face 22 is larger than the inclination A of the lower face 21. Accordingly, the thread is downward inclined as shown in FIG. 2.

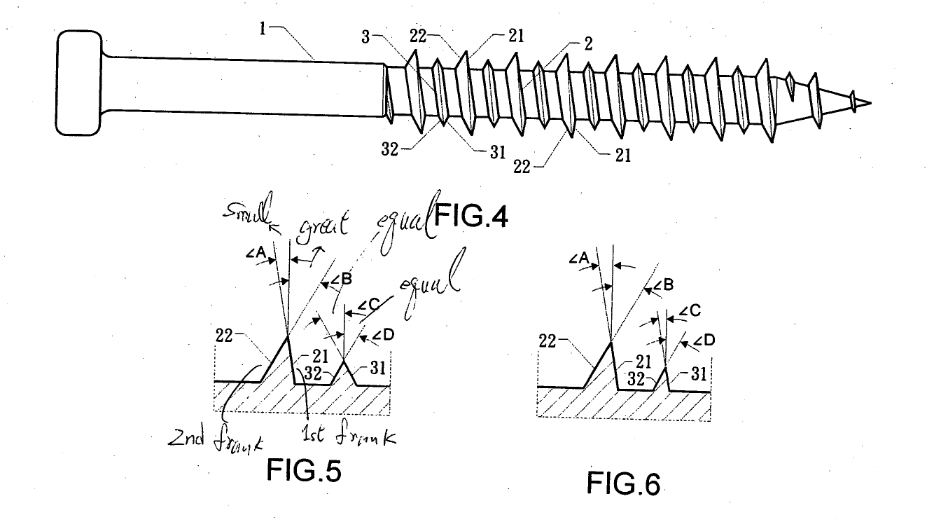

FIGS. 4 and 5 show a second embodiment of the present invention, in which a higher thread 2 and a lower thread 3 are formed on the rod body of the screw 1. In the structure of the lower thread 3, the inclination C of the lower face 31 is equal to the inclination D of the upper face 32. In the structure of the higher thread 2, the inclination A of the lower face 21 of the thread 2 is larger than zero degree, while smaller than the inclination B of the upper face 22 of the thread 2. That is, the inclination B of the upper face 22 is larger than the inclination A of the lower face 21. Accordingly, the higher thread is downward inclined as shown in FIG. 5.

FIG. 6 shows another aspect of the second embodiment of the present invention, in which a higher thread 2 and a lower thread 3 are formed on the rod body of the screw 1. In the structures of the higher thread 2 and lower thread 3, the inclinations A, C of the lower faces 21, 31 are larger than zero degree, while smaller than the inclinations B, D of the upper faces 22, 32. That is, the inclinations B, D of the upper faces 22, 32 are larger than the inclinations A, C of the lower faces 21, 31. Accordingly, the higher thread 2 and lower thread 3 are both downward inclined.

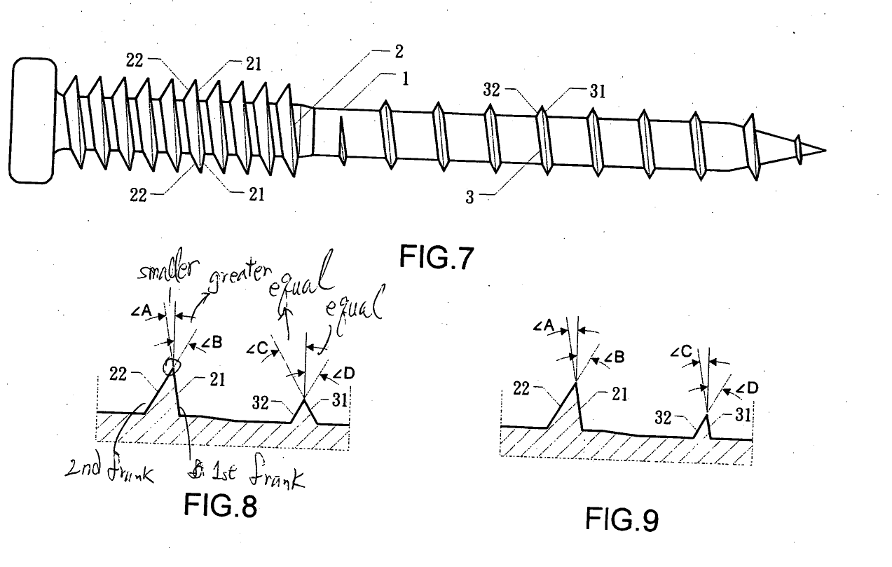

FIGS. 7 and 8 show a third embodiment of the present invention, in which a first thread 2 and a second thread 3 are formed on the rod body of the screw 1. In the structure of the second thread 3, the inclination C of the lower face 31 is equal to the inclination D of the upper face 32. In the structure of the first thread 2, the inclination A of the lower face 21 of the thread 2 is larger than zero degree, while smaller than the inclination B of the upper face 22 of the thread 2. That is, the inclination B of the upper face 22 is larger than the inclination A of the lower face 21. Accordingly, the first thread 2 is downward inclined as shown in FIG. 8.

FIG. 9 shows another aspect of the third embodiment of the present invention, in which a first thread 2 and a second thread 3 are formed on the rod body of the screw 1. In the structures of the first thread 2 and second thread 3, the inclinations A, C of the lower faces 21, 31 are larger than zero degree, while smaller than the inclinations B, D of the upper faces 22, 32. That is, the inclinations B, D of the upper faces 22, 32 are larger than the inclinations A, C of the lower faces 21, 31. Accordingly, the first thread 2 and second thread 3 are both downward inclined.

According to the above arrangements, the present invention has the following advantages:
1. Through actual test, it is proved that the screw of the present invention has better anti-pull quality than the conventional screw with upward inclined thread.
2. The screw of the present invention has simple structure and excellent utility.

The above embodiments are only used to illustrate the present invention, not intended to limit the scope thereof. Many modifications of the above embodiments can be made without departing from the spirit of the present invention.

1-6. (canceled)

7. A screw comprising:
a rod body having a tip, a head and a middle portion between the tip and the head;
a first thread formed on the middle portion and the tip; the first thread having a first flank and a second flank; the first flank of the first thread being facing toward the tip and the second flank of the first thread being facing toward the head; the first flank of the first thread being a flat surface and the second flank of the first thread being a flat surface; the first and second flank of the first thread being connected to one another;
each of the first flank and the second flank of the first thread having inclination angles with respect to the rod body; wherein an inclination angle of zero degree is perpendicular to a longitudinal axis of the rod body;
the inclination angle of the first flank of the first thread being smaller than that of the second flank of the first thread;
a second thread, the second thread having a small diameter than that of the first thread; the second thread being arranged on the middle portion and the tip; the first thread and second thread being arranged in alternating fashion with each other; the second thread having a first flank and a second flank; the first flank of the second thread being facing toward the tip and the second flank of the second thread being facing toward the head; the first flank of the second thread being a flat surface and the second flank of the second thread being a flat surface; the first and second flank of the second thread being connected to one another;
each of the first flank of the second thread and the second flank of the second thread having inclination angles with respect to the rod body; and
the inclination angle of the first flank of the second thread being equal to that of the second flank of the second thread.

8. A screw comprising:
a rod body having a tip, a head, a first middle portion adjacent to the tip portion, a second middle section between the first middle portion and the head; a diameter of the second middle section having a larger diameter that of the first middle portion;
a first thread formed on the first middle portion and the tip;
the first thread only having a first flank and a second flank; the first flank of the first thread being facing toward the tip and the second flank of the first thread being facing toward the head; each of the first flank and the second flank having inclination angles with respect to the rod body; the first flank of the first thread being a flat surface and the second flank of the first thread being a flat surface; the first and second flank of the first thread being connected to one another;
wherein an inclination angle of zero degrees is perpendicular to a longitudinal axis of the rod body; the inclination angle of the first flank of the first thread being equal to that of the second flank of the first thread;
a second thread formed on the second middle second; the second thread having a first flank and a second flank; the first flank of the second thread being facing toward the tip and the second flank of the second thread being facing toward the head;
each of the first flank of the second thread and the second flank of the second thread having inclination angles with respect to the rod body; the inclination angle of the first flank of the second thread being smaller than that of the second flank of the second thread.
